(19) United States
(12) Patent Application Publication
(10) Pub. No.: US 2020/0042925 A1
(43) Pub. Date: Feb. 6, 2020

(54) METHODS AND SYSTEMS FOR MEASURING AND IMPROVING REAL-TIME USER SATISFACTION IN HOSPITALITY INDUSTRY

(71) Applicant: DIGIVERV INC, PRINCETON, NJ (US)

(72) Inventors: Rohit Ramani, Bangalore (IN); Madhusudhan Reddy, Princeton, NJ (US)

(73) Assignee: DIGIVERV INC, PRINCETON, NJ (US)

(21) Appl. No.: 16/050,450

(22) Filed: Jul. 31, 2018

(51) Int. Cl. G06Q 10/06; G06Q 30/02; G06Q 20/38; G06K 9/00; G06F 9/54; G06F 15/18; H04L 9/06; H04W 4/029

(52) U.S. Cl. CPC G06Q 10/06395; G06Q 30/0282; G06Q 20/382; G06K 9/00302; H04L 2209/38; G06F 15/18; H04L 9/0637; H04W 4/029; G06F 9/542

(57) ABSTRACT

The embodiments herein provide methods and systems for measuring real-time user satisfaction in hospitality industry, a method includes delivering at least one service to at least one user by tracking location of the at least one staff in real-time. The method includes detecting at least one fault in functioning of at least one appliance present in at least one user staying area of a hospitality unit by collecting data from the at least one sensors connected to the at least one appliance. The method includes initiating blockchain based smart contract to fix the detected at least one fault. Based on feedback received from the at least one user, movements of the at least one staff and the data collected from the at least one sensor, the method includes predicting at least one user satisfaction score during a stay of the at least one user at the hospitality unit.

### TECHNICAL FIELD

The embodiments herein relate to the hospitality industry and, more particularly, to measuring and improving user satisfaction during a stay of a user at a hospitality unit.

### BACKGROUND

Generally, quality of service and user satisfaction may be the critical factors for success of hospitality industry. In order to achieve the user satisfaction, it is important to recognize and deliver services required by users in real-time.

Existing approaches used in the hospitality industry to improve the user satisfaction involve manual processes that support serving requirements of the users and handling problems being experienced by the users. However, the manual processes can be error prone and inconsistent due to dependency on skills of a staff. Also, in the existing approaches, the staff may not have real time information about the requirements of the users to deliver the services. Further, in the existing approaches, a management team may not receive information from the staff about the problems being experienced by the users at the earliest. Thus, causing inconvenience to the users.

Furthermore, in the existing approaches, the management team may not receive any real-time feedback to improve the user satisfaction since the user satisfaction is measured at the end of the stay. Thus, measuring the user satisfaction at the end of the stay does not provide any opportunity for improvement until the next visit of the users.

In addition, in the existing approaches, the user may provide feedback in open market places, social networks and so on, about the hospitality unit which may be subjected to personal biases and also may be contested about the management of the hospitality unit. Lack of immutable information about the user satisfaction score results in low quality reviews for new users in a market place.

### BRIEF DESCRIPTION OF THE FIGURES

The embodiments disclosed herein will be better understood from the following detailed description with reference to the drawings, in which:

FIG. 1 is an example overview diagram illustrating a hospitality system for measurement of real-time user satisfaction score in hospitality industry, according to embodiments as disclosed herein;

FIG. 2a is a block diagram illustrating various units of a service delivery engine for providing an automated service delivery to a user in hospitality industry, according to embodiments as disclosed herein;

FIG. 2b is a block diagram illustrating various units of a monitoring engine for detecting faults in functioning of appliances present in user staying areas of a hospitality unit, according to embodiments as disclosed herein;

FIG. 2c is a block diagram illustrating various units of a feedback engine for calculating a feedback score for a user, according to embodiments as disclosed herein;

FIG. 2d is a block diagram illustrating various units of a score prediction engine for calculating a real-time user satisfaction score for a user, according to embodiments disclosed herein;

FIG. 3 is a flow diagram illustrating a method for measuring real-time user satisfaction score in hospitality industry, according to embodiments as disclosed herein;

FIG. 4a is a flow diagram illustrating a method for calculating a performance score for staffs based on behavior of the staffs during front-desk related processes, according to embodiments as disclosed herein;

FIG. 4b is a flow diagram illustrating a method for awarding royalty points to a user based on validation of a user satisfaction score, according to embodiments as disclosed herein;

FIG. 4c is a flow diagram illustrating a method for awarding higher royalty points to at least one of a vendor, a staff and a user based on score comparison results, according to embodiments as disclosed herein;

FIG. 5 is an example scenario illustrating front-desk related services, wherein a front-desk feedback score and a performance score can be calculated for the user and a staff respectively while providing the front-desk related services, according to embodiments disclosed herein;

FIG. 6 depicts an example scenario, wherein an automated service delivery is provided to a user by tracking location of a staff, according to embodiments as disclosed herein; and

FIG. 7 depicts an example scenario, wherein blockchain based smart contract is initiated for fixing faults determined in functioning of appliances present in a user staying area of a hospitality unit, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose methods and systems for measuring and improving real-time user satisfaction score in hospitality industry.

A method disclosed herein includes delivering one or more services to one or more users staying at a hospitality unit in response to receiving information about real-time requirements of the one or more users. For delivering the one or more services, the method includes tracking location of one or more staffs in response to receiving one or more service requests from the one or more users. The location of the one or more staffs can be tracked using one or more devices carried by the one or more staffs and the one or more devices supports at least one of technologies like Beacon, iBeacon and Bluetooth Low energy (BLE) and so on. Based on the tracked location of the one or more staffs, the method includes assigning a staff from the one or more staffs to deliver the one or more services to at least one user. Further, the method includes automatically tracking closure of the one or more service requests and measuring time taken to serve the one or more service requests without any manual intervention.

Further, the method includes monitoring one or more appliances present in one or more user staying areas of the hospitality unit. For monitoring the one or more appliances, the method includes collecting information from one or more sensors connected to the one or more appliances. Based on the information collected from the one or more sensors, the method includes detecting one or more faults in functioning of the one or more appliances. Further, the method includes automatically initiating a blockchain based smart contract to fix the one or more faults detected in the functioning of the one or more appliances.

Further, the method includes predicting one or more user satisfaction scores for the one or more users during a stay of the one or more users at the hospitality unit. The one or more user satisfaction scores can be predicted based on at least one of feedback received including timely closure from the one or more users for the delivered services and front-desk services, movements of the one or more staffs and the data collected from the sensor related to the one or more appliances.

Further, the method includes validating the one or more user satisfaction scores on receiving one or more closure review responses from the one or more users. The one or more closure review responses indicate at least one of approval of the one or more user satisfaction scores and rejection of the one or more user satisfaction scores. Further, the method includes storing the one or more user satisfaction scores approved by the one or more users in an immutable database in a decentralized blockchain based platform. Thus, the approved or rejected user satisfaction scores cannot be modified or deleted by at least one of the user, a vendor and a hospitality unit management team. Further, the method includes comparing the one or more user satisfaction scores with one or more external review scores (related to the hospitality unit) provided by the one or more users in one or more external review sites. Furthermore, the method includes awarding one or more royalty points to the one or more users, the one or more vendors, the one or more staffs and so on based on at least one of the closure review responses and score comparison results.

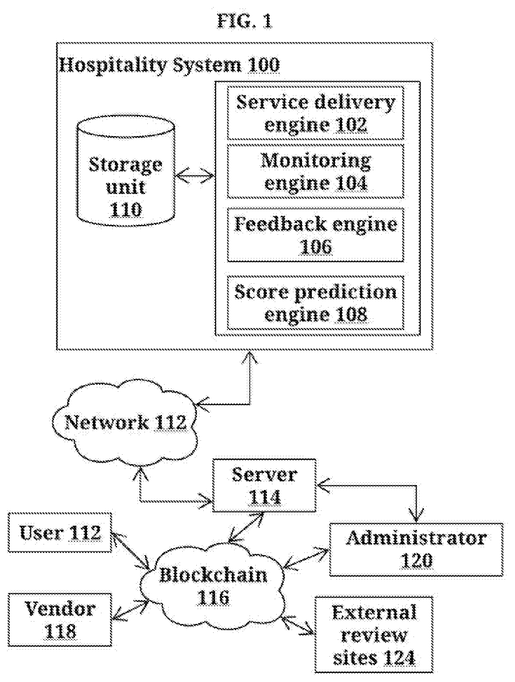

Referring now to the drawings, and more particularly to FIGS. 1 through 7, where similar reference characters denote corresponding features consistently throughout the figures, there are shown embodiments.

FIG. 1 is an example overview diagram illustrating a hospitality system 100 for measurement of real-time user satisfaction score in hospitality industry, according to embodiments as disclosed herein. Embodiments herein enable the hospitality system 100 to measure and improve the user satisfaction during a stay of the user(s) at a hospitality unit. The user can be a person who stays at the hospitality unit. The user can be at least one of a customer, a guest, a patient and so on. The hospitality unit can be a physical space where the user can stay, move and interact. Examples of the hospitality unit can be, but is not limited to, a hotel, a motel, a guest home, a hospital, a restaurant, a nursing home, a store and so on.

Further, the hospitality system 100 employs devices, such as, but not limited to, smart devices, electronic devices, IoT devices and so on in at least one user staying area of the hospitality unit for receiving service requests and feedback from the user. Examples of the devices employed in the user areas, can be, but is not limited to, a telephone, a tablet, a computer, a smart screen, a smart button (devices to send pre-configured message with click), a voice enabled device (smart speaker), and any other dedicated device or a generic device that can be connected to the hospitality unit such as mobile phones, smart phones, tablets, computers, and so on. Also, these devices can be connected devices present in the hospitality unit such as air conditioners (ACs), heaters, televisions (TVs) and so on which can sent the service request directly without any intervention from the user. Examples of the user area can be a room, a ward, a hospital bed, a dining area, a restroom and so on. The hospitality system 100 includes a service delivery engine 102, a monitoring engine 104, a feedback engine 106, a score prediction engine 108 and a storage unit 110.

The service delivery engine 102 can be configured to provide an automated service delivery to the user who stays at the hospitality unit. On receiving a service request from the user and/or a device present in the hospitality unit, the service delivery engine 102 tracks location and availability of suitable staffs and assigns the staff for delivering the service to the user. The service request can be, but is not limited to, a food and beverage related request, an amenity related request (requests for linen, pillows, and so on), a medical assistance related request and so on. The staffs herein can be persons who work at the hospitality unit. The staff can be at least one of an employee, a housekeeper, a server/a waiter, a technician, a nurse, an attendant, a receptionist and so on.

In addition, the service delivery engine 102 can calculate a staff availability score by monitoring movements of the staffs. The staff availability score can be computed based on parameters such as, but not limited to, time taken to close the service request, average time taken to close the similar type of service in past data, standard deviation in a closure time based on the past data and so on. For example, if the time taken by the staff to close the service request is higher, then the service delivery engine 102 assigns a lower staff availability score. Information about the staffs can be transmitted to a server 114 through a network 112. The network 112 can be, but is not limited to, the Internet, a Wi-Fi network, a Local Area Network (LAN), a Wide Area Network (WAN), a cellular network, a fiber network, a cable network and so on. In addition, the service delivery engine 102 can store the staff availability score in the blockchain 116 which cannot be modified.

The monitoring engine 104 can be configured to monitor appliances present in the user staying areas of the hospitality unit. The appliances can be at least one of a smart device, an electronic device, and an Internet of Things (IoT) device. Examples of the appliances can be, but is not limited to, an air conditioner (AC), a lighting system, a heater, a cooler, a music player, a mobile phone, tablet, medical equipment, a smart screen, a smart button, a smart speaker and so on.

The monitoring engine 104 monitors the appliances by collecting data from sensors connected to the appliances. Based on the data collected from the sensors, the monitoring engine 104 detects the fault in the functioning of the appliances. The sensors can be, but is not limited to, an environmental sensor device which measures environment parameters like temperature, humidity, ambiance light, motion and so on, a current sensor device which measures current usage of the appliances in real-time basis and so on. Further, the monitoring engine 104 transmits the data related to the appliances and the detected faults to the server 114 through the network 112. The server 114 stores the information related to the detected faults in a blockchain 116 that can be accessed by an administrator(s) 120 of the hospitality unit.

Further, the monitoring engine 104 initiates a smart contract of the blockchain 116 by detecting faults in the appliances. The smart contract may contain a pre-defined set of rules for enforcing an agreement. In an embodiment, the agreement herein refers to contract initiation between a hospitality unit management team and any vendors to repair the detected faults identified in the appliances. The smart contract facilitates, verifies and enforces the agreement. For example, the detected faults in the appliances trigger the initiation of the smart contract which sends a repair request to the vendor for repairing the detected faults based on the pre-defined set of rules. In an embodiment, the smart contract can be initiated automatically based on a type or severity level of the defects. On receiving the repair request from the smart contract, the vendor repairs the appliance. After repairing the appliances, the monitoring engine 104 detects proper functioning of the appliances and triggers the closure and settlement of the smart contract. Thus, manual intervention may not be needed to initiate and close the smart contract.

The monitoring engine 104 can be further configured to calculate a digital comfort score using the data collected from the sensors connected to the appliances and the information stored in the blockchain 116. The monitoring engine 104 can assign a low digital comfort score by determining that the appliances are not working properly. The monitoring engine 104 can assign a high digital comfort score by determining that appliances are working properly.

The feedback engine 106 can be configured to receive a service feedback from the user after completion of each service delivery. Also, the feedback engine 106 receives a front-desk feedback from the user after completion of front-desk related processes/services (user check-in process, transport related service, local guide related service, restaurant related services and so on). Further, the feedback engine 106 calculates a feedback score based on emotions detected in the service feedback and the front-desk feedback received from the user. In addition, the feedback engine 106 receives the feedback from the user after the end of the user's stay at the hospitality unit. In an embodiment, the feedback engine 106 receives external review scores from external review sites 124 such as, but not limited to, third party websites, social networking sites, forums, and so on. The external review scores can be scores/ratings provided by the user for the hospitality unit in the external review sites after visiting the hospitality unit.

The score prediction engine 108 can be configured to predict a user satisfaction score for the user during a stay of the user at the hospitality unit. In an embodiment, the score prediction engine 108 uses at least one of a supervised machine learning model and an unsupervised machine learning model to calculate the user satisfaction score. The user satisfaction score can be a metric assigned to the user which indicates ongoing experience associated with the user while staying at the hospitality unit. The score prediction engine 108 calculates the user satisfaction score using at least one of the staff availability score, the digital comfort score and the feedback score. The score prediction engine 108 stores the user satisfaction score in the blockchain 116.

For example, when the user requests for switching on/off the appliance at certain time/temperature, the appliance suppose to work as instructed. If the monitoring engine 104 determines that the appliance is worked as expected, then the score prediction engine 108 assigns a higher user satisfaction score. Otherwise, the score prediction engine 108 assigns a lower user satisfaction score. Further, when the user requests for a room service, the service delivery engine 102 tracks timely delivery of the service request supplemented by closure of user review. In an embodiment, the timely delivery can be analyzed based on previous data identified for the similar type of service request. When the service delivery engine 102 determines the timely delivery of the service request, then the score prediction engine 108 assigns the higher user satisfaction score. Otherwise, the score prediction engine 108 assigns the lower satisfaction score. In addition, when the user calls helpdesk for non-room service for services such as, but not limited to, local guides, cab booking, and so on, the feedback engine 106 analyzes conversation exhibited emotions. When the feedback engine 106 determines that the emotions exhibited by the user may be positive, then the score prediction engine 108 assigns the higher user satisfaction score. The score prediction engine 108 assigns the lower user satisfaction score when the emotions exhibited by the user may be negative.

Further, in response to determining the lower user satisfaction scores, the hospitality unit management team may take an action to improve the user satisfaction score by providing facilities such as, but not limited to, providing discounted food and beverage services, providing discounted Sanus Per Aquam (SPA) services and so on.

The score prediction engine 108 transmits the calculated user satisfaction score to the server 114 through the network 112 that can be accessed by the administrator 120. In an embodiment, the score prediction engine 108 continuously calculates and updates the user satisfaction score in order to check ongoing experience associated with the user at the hospitality unit. Thus, the user experience can be improved in real-time.

In an embodiment, the score prediction engine 108 validates the user satisfaction scores by sending a review closure request to the user. In response to the review closure request, the score prediction engine 108 receives a closure review response from the user which includes at least one of an approval input and a rejection input. The approval input and the rejection input indicates approval of the user satisfaction score and rejection of the user satisfaction score respectively. Further, the score prediction engine 108 stores at least one of the approved user satisfaction score and the rejected user satisfaction score in the blockchain 116. Thus, the approved or rejected user satisfaction scores cannot be modified or deleted by at least one of the user, a vendor and a hospitality unit management team. Further, the hospitality unit management team cannot selectively hide the user satisfaction score (ratings) approved by the user. Thus, the user satisfaction scores stored in the blockchain 116 may not be confined to wall garden of a single market place which helps at least one of the user, the vendor and the hospitality unit management team to get benefited from the transparent reputation.

In another embodiment, the score prediction engine 108 compares the user satisfaction scores with the external review scores (obtained from the feedback engine 106). The score prediction engine 108 stores score comparison results in the blockchain 116.

In yet another embodiment, the score prediction engine 108 awards royalty points to at least one of the vendor, the staffs and the user based on at least one of the closure review response received from the user and the score comparison results. The royalty points can be, but is not limited to, a token, a rewarding score, a pseudo currency, a currency, a referral point, a coupon, a discounted offer and so on.

The storage unit 110 can be configured to store at least one of the service requests received from the users, the data collected from the sensors regarding the appliances, feedback received from the users, the user satisfaction scores and so on. The storage unit 110 includes at least one of a file server, a data server, a server, a cloud and so on.

The server 114 can be configured to store information about the staffs, the user(s) and the appliances, the data collected from the sensors regarding the appliances, feedback received from the users and so on. The information stored in the server 114 can be accessed by the administrator 120.

The blockchain 116 can be configured to store the staff availability score, information about the defects detected in the appliances, the user satisfaction score, the external review scores obtained from the external review sites 124 and so on. The information stored in blockchain 116 can be accessed by at least one of the user(s) 122, the vendor (s) 118 and the administrator 120.

FIG. 1 shows exemplary blocks of the hospitality system 100, but it is to be understood that other embodiments are not limited thereon. In other embodiments, the hospitality system 100 may include less or more number of blocks. Further, the labels or names of the blocks are used only for illustrative purpose and does not limit the scope of the embodiments herein. One or more blocks can be combined together to perform same or substantially similar function in the hospitality system 100.

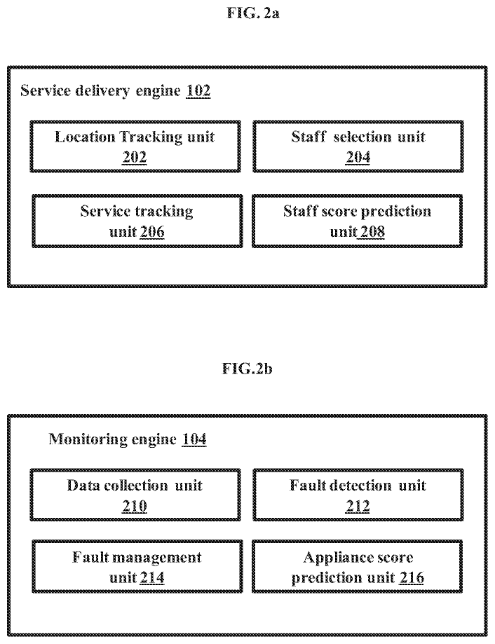

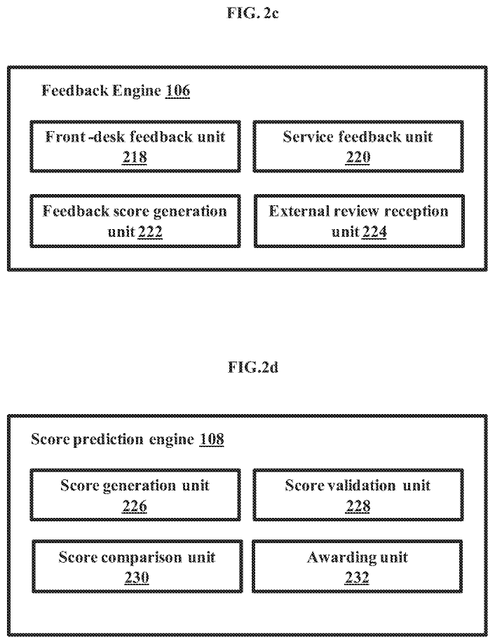

FIG. 2a is a block diagram illustrating various units of the service delivery engine 102 for providing the automated service delivery to the user in the hospitality industry, according to embodiments as disclosed herein. The service delivery engine 102 includes a location tracking unit 202, a staff selection unit 204, a service tracking unit 206 and a staff score prediction unit 208.

The location tracking unit 202 can be configured to track the location or movements of the staffs on receiving the service request from the user. In order to track the location of the staffs, the unique ID may be assigned to a device(s) which is carried by each staff. The device can be a mobile phone, a smart phone, tablet, a phablet, a personal digital assistant (PDA), a laptop, a computer, a wearable computing device, an Internet of Things (IoT) device, a sensor or any other device which supports at least one of technologies like, Beacons, iBeacon, Bluetooth Low Energy (BLE), Near-field communication (NFC), Global Positioning System (GPS) and so on. The device carried by each staff acts as a transmitter. The location tracking unit 202 configures an advertising frequency for the device carried by the staffs. Further, the location tracking unit 202 places receiver nodes in the user staying areas (rooms, wards, and so on) of the hospitality unit. The location tracking unit 202 determines the location of the at least one staff when at least one receiver node receives radio frequency transmitted by the at least one device carried by the at least one staff.

For example, the receiver nodes are placed in each room and well designated area of a hotel and beacons are distributed to the staff who always carry the device supporting the beacons. The location tracking unit 202 may understand one to one association/relationship between a beacon ID and a staff ID. Since, the location tracking unit 202 may know the exact location of the receiver nodes, the staff who is near to the specific receiver node can be identified and the presence of a staff to a designated area in the hotel can be established by detecting proximity of any beacon.

The staff selection unit 204 can be configured to assign the suitable staff from the staffs for delivering the service to the user based on the tracked location of the staffs. The staff selection unit 204 determines the staff who is physically closest to location of the user who placed the service request and assigns the same staff to serve the request. In an embodiment, along with the tracked location, the staff selection unit 204 can monitor factors such as, but not limited to, work load, availability, skills/abilities, roles, evaluation scores and so on to select the staff for delivering the service to the user. The evaluation scores can be calculated using the feedback received from the user for the staff after the delivery of the service.

The service tracking unit 206 can be configured to track completion of the service delivery. The service tracking unit 206 tracks the service delivery completion on receiving scanned information from the receiving node placed at the user staying area. The scanned information includes the scanned unique ID of the device carried by the staff while serving the request. For example, based on a place of origin of the service request, the service tracking unit 206 determines the corresponding receiver node at the place from where the service request is received. Once the service request is raised, the service tracking unit 206 tracks a specific beacon ID which is being carried by the staff who is supposed to deliver the raised request. The service tracking unit 206 closes the raised request, only when the specific beacon proximity is detected by the receiver node which is present at the place from where the service request is received. In an embodiment, the service tracking unit 206 tracks the service delivery completion on receiving the feedback from the user.

The staff score prediction unit 208 can be configured to calculate the staff availability score. The staff availability score can be a composite score. The staff score prediction unit 208 analyzes time series data such as, but not limited to, the movement of the staffs while serving the request, time taken by the staff to deliver the service, user inputs received from the user for the staff after serving the request, user feedback, and so on. Further, the service delivery engine 102 measures time taken from receiving the service request to closure of the service request and feeds to a periodically updated analytical model to check whether the service request delivery was done in time based on the past data. On receiving outputs from the analytical model, the staff score prediction unit 208 calculates the staff availability score. The calculated staff availability score can be complemented by instant verification from the user through short messaging application (SMS), or any suitable applications. Once the staff availability score for the delivery of the service request is raised and accepted, the staff score prediction unit 208 stores the staff availability score in the blockchain 116 which cannot be modified by at least one of the user and hospitality unit management team. The staff availability score can be further used to calculate the user satisfaction score.

FIG. 2b is a block diagram illustrating various units of the monitoring engine 104 for detecting faults in the functioning of the appliances present in the user staying areas of the hospitality unit, according to embodiments as disclosed herein. The monitoring engine 104 includes a data collection unit 210, a fault detection unit 212, a fault management unit 214 and an appliance score prediction unit 216.

The data collection unit 210 can be configured to receive the data from the sensors connected to the appliances present in the user staying areas of the hospitality unit. The sensors, can be, environment sensors such as, but not limited to, room occupation sensors, temperature sensors, humidity sensors, thermostats, light controllers, telephone off hook sensors, motion sensors, music controllers, and so on.

The fault detection unit 212 can be configured to analyze the data collected from the sensors connected to the appliances and detect the faults in the functioning of the appliances. The fault detection unit 212 uses at least one of the supervised machine learning model and the unsupervised machine learning model to detect the faults. The supervised machine model and the unsupervised machine learning model constantly monitor the data collected from the sensors and learn about the functioning of the appliances to classify the functioning of the appliances as faulty/abnormal, normal and so on. The fault detection unit 212 can be further configured to classify severity levels of the detected faults using a pre-defined threshold. In an embodiment, the pre-determined threshold can vary based on at least one of time, day, external conditions to which the appliances are subjected such as, but not limited to, outside/inside temperature, ambient light, room (user staying areas) occupancy and so on. Further, the fault detection unit 212 can use the supervised learning model which uses training data (previous learning data) to classify the severity levels of the detected faults.

The fault management unit 214 can be configured to initiate the blockchain based smart contract to store the logs related to the faults determined in the functioning of the appliances. The logs can provide information about the status/condition of the appliances, the detected faults, the severity levels of the detected faults and so on. The smart contract stores the logs in a blockchain based public ledger/shared ledger and executes the agreement based on pre-defined configurations. The agreement can be a contract initiative between the hospitality management team and any vendors for fixing the detected faults.

The smart contract can be configured with a pre-defined set of rules based on factors, such as, but not limited to, number of appliances present at the hospitality unit, status of the appliances, conditions of the appliances, faults, severity levels of the faults, previous learning (about detected faults and severity level of the detected faults), data collected from the sensors regarding the appliances and so on. In an embodiment, the pre-defined set of rules/terms of the contract can be, but is not limited to, time/events to contact vendor, pre-agreed pricing, vendor type to contact, a request type (a repair request/replace request) to raise, environmental footprint, closure time for the faults, applicable penalty charges for taking extra time to fix the defects and so on. In an embodiment, the pre-defined set of rules can be changed dynamically based on changes identified in the factors such as, but not limited to, number of appliances present at the hospitality unit, status of the appliances, conditions of the appliances, previous learning (about detected faults and severity level of the detected faults), data collected from the sensors regarding the appliances and so on.

The smart contract uses an application which can be shared on the blockchain based public ledger to disclose the request type and related terms of contract to enter into agreement with the hospitality unit management team. The application can be accessed by the vendor to enter in to the agreement with the hospitality unit management team. Further, the smart contract determines and verifies the vendors who wish to enter into the agreement according to the terms of contract for repairing the faults detected in the functioning of the appliances or for replacing the appliances. For example, the smart contract determines and validates a best technician (vendor) who can enter into the agreement according to the terms of contract such as, pre-agreed pricing, closure time, and so on for repairing the AC when the faults are detected in the functioning of the AC. Based on the severity level of the fault, the smart contract raises the replace request, determines and validates the best vendor who can replace the AC according to the terms of the contract.

After determining and validating the vendor, the smart contract executes the agreement by updating information about the vendor in the block chain based public ledger. The agreement executed by the smart contract enables the vendor to fix the faults/replace the appliance. After entering into the agreement, the vendor can be enabled to fix the fault/replace the appliance. After fixing the determined faults by the vendor, the smart contract may receive an acknowledgement message from the vendor. On receiving the acknowledgement message from the vendor, the smart contract validates current condition of the appliances by receiving information from the fault detection unit 212. Further, the smart contract updates the current condition of the appliances in the blockchain based public ledger. The smart contract may remain open by determining that appliance is not fixed from the current condition of the appliances. The smart contract may settle the agreement by applying applicable penalty charges for taking extra time to fix the defects.

In response to determining absence of the faults in functioning of the appliances, the smart contract settles the agreement by issuing payment to the vendor based on the terms of the contract. In order to settle the agreement, the blockchain based smart contract may register an account associated with the hotel management unit to one or more payment gateways such as unified payment interface (UPI) or the like. Also, the vendor may associate the account with the same payment gateway. In response to determining absence of the faults in functioning of the appliances, the smart contract can initiate the payment via the payment gateway API for transferring the currency from the account associated with the hotel management unit to the account associated with the vendor. Once the agreement is settled, the fault management unit 214 may close the blockchain based smart contract.

The appliance score prediction unit 216 can be configured to calculate the digital comfort score. The appliance score prediction unit 216 predicts the digital comfort score by analyzing the data collected from the sensors related to the appliances and streaming data for the appliances in the user staying areas. For example, when the appliances are functioning according to the user requirements or the functioning of the appliance is normal, the appliance score prediction unit 216 assigns a higher digital comfort score. The appliance score prediction unit 216 assigns a lower digital comfort score when the faults are determined in the functioning of the appliances. In an embodiment, the digital comfort score can be calculated using the logs related to the fault stored in blockchain 116. The digital comfort score can be further used to calculate the user satisfaction score.

FIG. 2c is a block diagram illustrating various units of the feedback engine 106 for calculating the feedback score for the user, according to embodiments as disclosed herein. The feedback engine 106 includes a front-desk feedback unit 218, a service feedback unit 220, a feedback score generation unit 222 and an external review reception unit 224.

The front-desk feedback unit 218 can be configured to generate a performance score for the staffs (who work at the front-desk) and a front-desk feedback score for the user during the front-desk related processes (for example: user check-in process). In an embodiment, the front-desk related services include services such as, but not limited to, transport related service, local guide related service, restaurant related services, SPA related services, Gym related services and so on.

The front-desk feedback unit 218 generates the feedback score and the performance score using real-time video analytics. Based on the real-time video analytics, the front-desk feedback unit 218 monitors the behavior of the staffs during each step of the user check-in process. The user check-in process may include multiple steps, such as, but not limited to, greeting the user upon the user arrival, receiving booking and personal details from the user, verifying the details, assigning the hospitality areas/rooms and so on. The front-desk feedback unit 218 separates each step, assigns time-stamp to each step of the user check-in process and identifies skipping of any step of the user check-in process by the staff. Based on the monitored behavior of the staffs, the front-desk feedback unit 218 generates the performance score for the staffs. In an embodiment, the performance score can be used for calculating the staff availability score.

Further, the front-desk feedback unit 218 performs face detection/verification and determines facial emotion of the user during each step of the user check-in process using the real-time video analytics. In addition, the front-desk feedback engine 218 receives the front-desk feedback from the user after completion of the check-in process (or any front-desk related process). In an embodiment, the user can provide the feedback using at least one of devices having smart portable buttons, a software application, with soft buttons for different c-sat levels, running on Tablet (android, iOS) or Desktop (windows, MAC, Linux) with similar capability and so on. Each smart portable button may have pre-assigned feedback such as, but not limited to, ‘very satisfied’, ‘satisfied’, ‘not satisfied’ and so on. Based on the facial emotion of the user and the front-desk feedback received from the user, the front-desk feedback engine 218 generates the front-desk feedback score for the user. In an embodiment, the front-desk feedback score can be generated based on the performance score of the staffs.

The service feedback unit 220 can be configured to receive the service feedback from the user after completion of each service delivery. In an embodiment, the user can provide the feedback using devices such as, but not limited to, smart screens, smart buttons, smart speakers, smart devices supporting chatbot, a web browser, an application resident on one or more devices, an interactive voice response (IVR) and so on. On receiving voice inputs (the service feedback) from the user, the service feedback unit 220 detects emotions in voice of the user. The service feedback unit 220 converts the voice into samples and correlates the samples with pre-stored samples determined for different emotions to predict the emotions in the voice. The service feedback unit 220 uses a supervised learning model to predict the emotions in the voice of the user. For example, positive emotions such as happy, satisfied and so on can be used for higher satisfaction scoring and negative emotions such as angry, sad and so on can be used for lower satisfaction scoring. Based on the detected emotions, the service feedback unit 220 generates a service feedback score for the user.

The feedback score generation unit 222 can be configured to generate the feedback score for the user using the front-desk feedback score and the service feedback score.

The external review reception unit 224 can be configured to identify the external review scores provided by the user in the external review sites. The external review scores can be provided by the user after check-out from the hospitality unit. The external scores can be compared with the user satisfaction scores (generated by the score prediction engine 108) for rewarding at least one of the vendor, the user and the staff with the royalty points.

FIG. 2d is a block diagram illustrating various units of the score prediction engine 108 for calculating the real-time user satisfaction score for the user, according to embodiments disclosed herein. The score prediction engine 108 includes a score generation unit 226, a score validation unit 228, a score comparison unit 230 and an awarding unit 232.

The score generation unit 226 can be configured to generate the user satisfaction score for the user during the user's stay at the hospitality unit. The score generation unit 226 generates the user satisfaction score based on weightage of the feedback score generated for the user, the staff availability score and the digital comfort score. For example, the feedback score may have the weightage of 85% (the front-desk feedback score may have weightage of 15% and the service feedback score may have weightage of 70%) and the staff availability score and the digital comfort score may have weightage of another 15%. The score generation unit 226 may generate the user satisfaction score for the stay based on an average weightage of the feedback score, the staff availability score and the digital comfort score. The score generation unit 226 stores the calculated user satisfaction score in the blockchain 116.

The score validation unit 228 can be configured to send the review closure request to the user in order to validate the user satisfaction score (generated by the score generation unit 226). In response to the review closure request, the score validation unit 228 receives the at least one of the approval input and the rejection input from the user indicating the at least one of approval of the user satisfaction score and rejection of the user satisfaction score. Once the user satisfaction is approved/rejected, the score validation unit 228 stores at least one of the approved user satisfaction score and the rejected user satisfaction score in the blockchain 116. The user satisfaction score cannot be modified or deleted by at least one of the user, the vendor and the hospitality unit management team since the validated user satisfaction score is stored in the blockchain 116. Thus, real-time generation of the user satisfaction score, validating the user satisfaction score and storing of the user satisfaction score in the blockchain 116 can have major impact in removing the biases originated due to lag in review or culture. For example, American gives good overall score where as Japanese or Nordic will typically give lower score for the similar experience.

The score comparison unit 230 can be configured to compare the user satisfaction score (validated score) and the external review score provided by the user in the external review sites. The score comparison unit 230 may store results of the comparison in the blockchain 116.

The awarding unit 232 can be configured to award at least one of the user, the vendor and the staff with the royalty points. The awarding unit 232 awards the user with the royalty points by identifying the time taken by the user to provide the response for the review closure request. Further, the royalty points can be awarded to the user in order to encourage unbiased reviews. Cost of the royalty points can be distributed between vendors/hospitality management team and/or participating marketplaces.

In an embodiment, the awarding unit 232 awards at least one of the user, the vendor, and the staff with the royalty points based on the score comparison results. For example, the awarding unit 232 awards higher royalty points to the at least one of the vendor and the staff when the external review score is determined as higher than the user satisfaction score generated by the score generation unit 226.

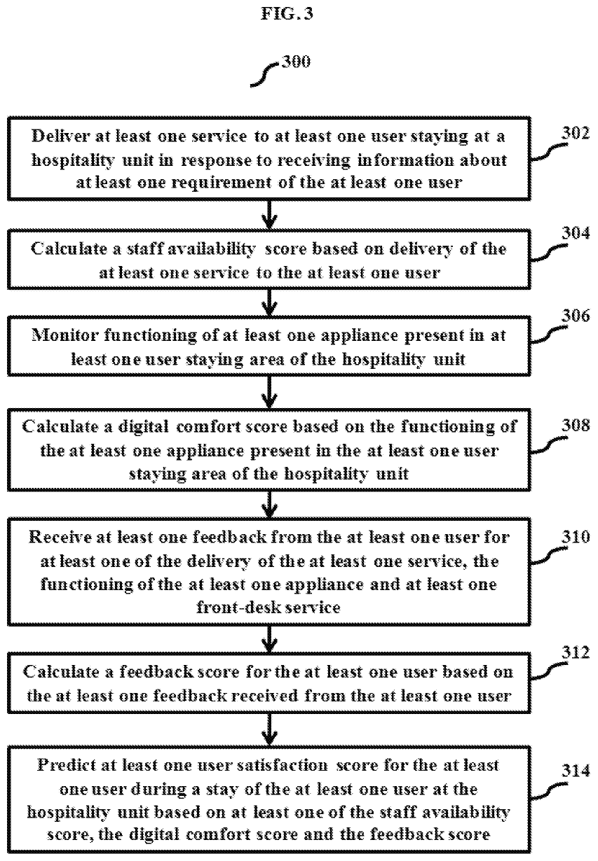

FIG. 3 is a flow diagram 300 illustrating a method for measuring real-time user satisfaction score in hospitality industry, according to embodiments as disclosed herein.

At step 302, the method includes delivering, by the service delivery engine 102, the service to the user staying at the hospitality unit in response to receiving information about at least one requirement of the user. On receiving the service request from the user, the service delivery engine 102 tracks the location/movements of the staffs present at hospitality unit. Based on the tracked location, the service delivery engine 102 selects the staff who is closest to the location of the user and assigns the staff for delivering the service to the user. The location of the staffs can be tracked using the devices carried by the staffs that support at least one of the technologies like, Beacon, iBeacon, BLE, NFC and so on. Further, the service delivery engine 102 tracks completion of delivery of the service by scanning the unique identifier of the devices carried by the staffs.

At step 304, the method includes calculating, by the service delivery engine 102, a staff availability score based on the delivery of the service to the user. The service delivery engine 102 calculates the staff availability score using the time series data related to at least one of the movement of the staff while delivering the service, the time taken by the staff to deliver the service and the input received from the user for the staff after delivering the service.

At step 306, the method includes monitoring, by the monitoring engine 104, the functioning of the appliances present in the user staying areas of the hospitality unit. The monitoring engine 104 collects the data from the sensors connected to the appliances and detects the faults in the functioning of the appliances. The monitoring engine 104 may use the supervised and the unsupervised machine learning models to detect the fault in the functioning of the appliances. Further, the monitoring engine 104 initiates the blockchain based smart contract to fix the faults detected in the functioning of the appliances. Thus, the faults in the appliances can be detected and fixed without involving any manual processes.

At step 308, the method includes calculating, by the monitoring engine 104, a digital comfort score based on the functioning of the appliance present in the user staying areas of the hospitality unit. The monitoring engine 104 analyzes the data collected from the sensors to detect the faults in the functioning of the appliances. Based on the detected faults and the functioning of the appliances, the monitoring engine 104 calculates the digital comfort score.

At step 310, the method includes receiving, by the feedback engine 106, the feedback from the user for at least one of the delivery of the service, the functioning of the appliances and the front-desk services. The feedback includes at least one of the front-desk feedback and the service feedback. The service feedback includes the feedback received from the user after the delivery of the service. In an embodiment, the service feedback may include the feedback from the user regarding the functioning of the appliances. The front-desk feedback includes the feedback received from the user after the completion of the front-desk related services/processes.

At step 312, the method includes calculating, by the feedback engine 106, the feedback score for the user based on the feedback received from the user. The feedback engine 106 receives the service feedback after completion of the delivery of the service and identifies the emotion associated with the service feedback. Based on the identified emotion, the feedback engine 106 calculates the service feedback score. The feedback engine 106 receives the front-desk feedback after completion of the front-desk related process. Also, the feedback engine 106 detects the facial emotion of the user during the front-desk related processes. The facial emotion can be detected using the real-time video analytics. Based on the facial emotion and the front-desk feedback, the feedback engine 106 calculates the front-desk feedback score. Further, the feedback engine 106 calculates the feedback score for the user using the service feedback score and the front-desk feedback score.

At step 314, the method includes predicting, by the score prediction engine 108, the user satisfaction score during the stay of the user at the hospitality unit. The score prediction engine 108 predicts the user satisfaction score using at least one of the staff availability score, the digital comfort score and the feedback score. In addition, the score prediction engine 108 stores the user satisfaction score in the blockchain 116 which cannot be modified or deleted. Thus, real automated score being generated can be managed by a decentralized blockchain.

The various actions, acts, blocks, steps, or the like in the method and the flow diagram 300 may be performed in the order presented, in a different order or simultaneously. Further, in some embodiments, some of the actions, acts, blocks, steps, or the like may be omitted, added, modified, skipped, or the like without departing from the scope of the invention.

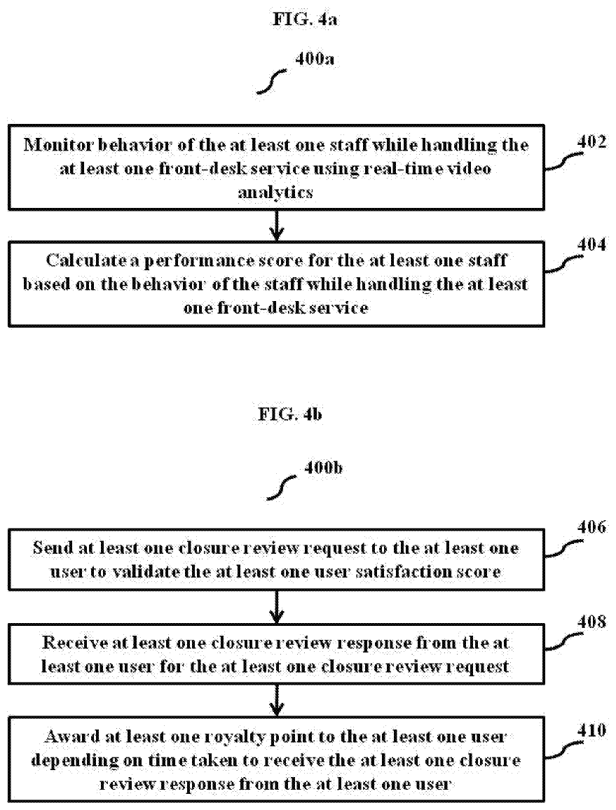

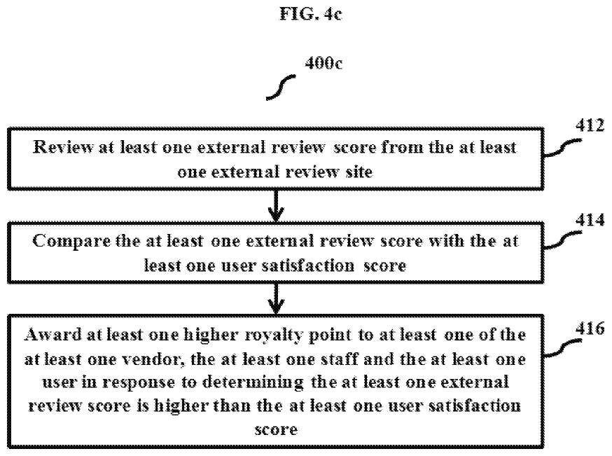

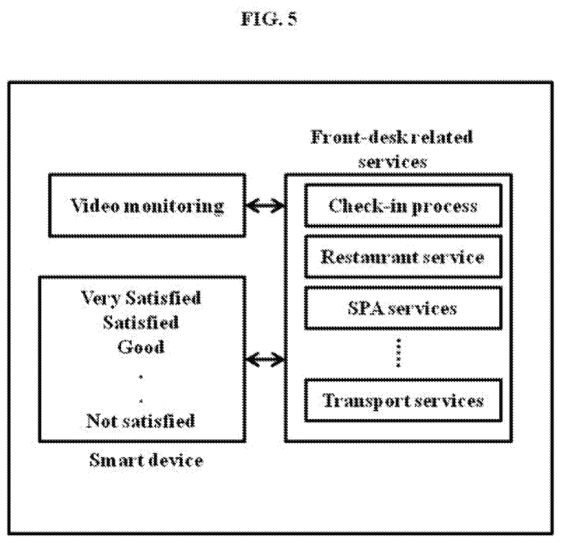

FIG. 4a is a flow diagram 400a illustrating a method for calculating the performance score for the staffs based on behavior of the staffs during front-desk related processes, according to embodiments as disclosed herein.

At step 402, the method includes monitoring, by the feedback engine 106, the behavior of the staffs while handling the front-desk related processes. The feedback engine 106 monitors the behavior of the staffs using the real-time video analytics. At step 404, the method includes calculating, by the feedback engine 106, the performance score for the staffs based on the monitored behavior of the staffs while handling the front-desk related processes.

The various actions, acts, blocks, steps, or the like in the method and the flow diagram 400a may be performed in the order presented, in a different order or simultaneously. Further, in some embodiments, some of the actions, acts, blocks, steps, or the like may be omitted, added, modified, skipped, or the like without departing from the scope of the invention.

FIG. 4b is a flow diagram 400b illustrating a method for awarding the royalty points to the user based on validation of the user satisfaction score, according to embodiments as disclosed herein.

At step 406, the method includes sending, by the score prediction engine 108, the review closure request to the user to validate the user satisfaction score. The review closure request includes the user satisfaction score.

At step 408, the method includes receiving, by the score prediction engine 108, the closure review response from the user in response to the review closure request. The closure review response includes at least one the approval input and the rejection input. The approval input indicates the approval of the user satisfaction score. The rejection input indicates the rejection of the user satisfaction score. The score prediction engine 108 stores the approved/rejected user satisfaction score in the blockchain 116. Thus, the validated user satisfaction score stored in the blockchain 116 cannot be modified by administrator of the hospitality unit.

At step 410, the method includes awarding, by the score prediction engine 108, the royalty points to the user depending on the time taken to receive the closure review response from the user. Thus, encouraging for the unbiased reviews.

The various actions, acts, blocks, steps, or the like in the method and the flow diagram 400b may be performed in the order presented, in a different order or simultaneously. Further, in some embodiments, some of the actions, acts, blocks, steps, or the like may be omitted, added, modified, skipped, or the like without departing from the scope of the invention

FIG. 4c is a flow diagram 400c illustrating a method for awarding the higher royalty points to at least one of the vendor, the staff and the user based on score comparison results, according to embodiments as disclosed herein.

At step 412, the method includes receiving, by the feedback engine 106, the external review scores from the external review sites. The external review scores may be the scores provided by the user for the hospitality unit in the external review sites.

At step 414, the method includes comparing, by the score prediction engine 108, comparing the external review scores with the user satisfaction score.

At step 416, the method includes awarding, by the feedback engine 106, the higher royalty points to the at least one of the vendors, the staffs and the user in response to determining that the external review scores are higher than the user satisfaction score.

The various actions, acts, blocks, steps, or the like in the method and the flow diagram 400c may be performed in the order presented, in a different order or simultaneously. Further, in some embodiments, some of the actions, acts, blocks, steps, or the like may be omitted, added, modified, skipped, or the like without departing from the scope of the invention.

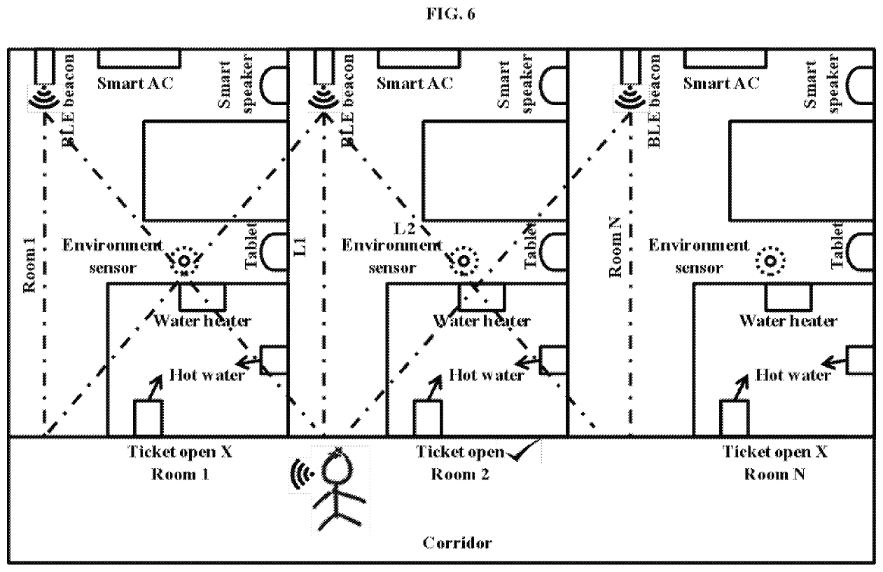

FIG. 5 is an example scenario illustrating the front-desk related services, wherein the front-desk feedback score and the performance score can be calculated for the user and the staff respectively while providing the front-desk related services, according to embodiments disclosed herein. As illustrated in FIG. 5, the front-desk related services include services such as, but not limited to, user check-in processes, restaurant related services, SPA services, transport related services and so on. The feedback engine 106 receives real-time video analytics from camera or other suitable devices employed at the front-desk of the hospitality unit. The feedback engine 106 determines the behavior of the staffs during each step of the front-desk related processes. Based on the behavior of the staffs, the feedback engine 106 calculates the performance score for the staffs which can be used in generating the staff availability score.

Further, the feedback engine 106 identifies the facial emotion of the user during each step of the front-desk related processes based on the real-time video analytics. In addition, the feedback engine 106 receives the front-desk feedback from the user after completion of the front-desk related processes. The user can provide the front-desk feedback using the smart device which has pre-defined feedback buttons (very satisfied, satisfied, good, not satisfied and so on). The feedback engine 106 calculates the feedback score for the user based on the facial emotion of the user and the front-desk feedback received from the user. The feedback score can be used for the calculating the user satisfaction score.

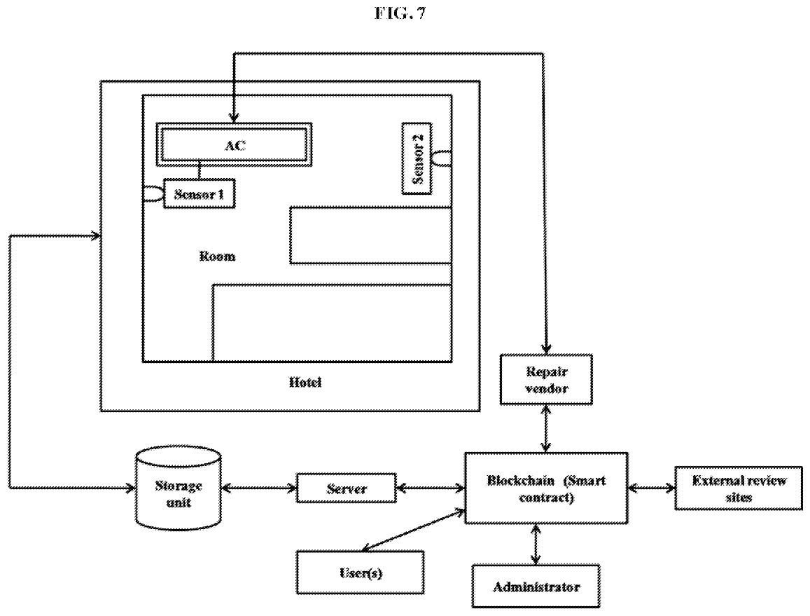

FIG. 6 depicts an example scenario, wherein the automated service delivery can be provided to the user by tracking the location of the staff, according to embodiments as disclosed herein. For example, the hospitality unit can be a hotel and the user staying areas can be rooms of the hotel as illustrated in FIG. 6. Embodiments herein deploy the receiver nodes in each room of the hotel and connect the sensors to the appliances (AC, water heater and so on) present in the each room of the hotel. Further, the embodiments herein places the smart devices such as, but not limited to, tablet, smart speakers in the each room which allow guests to place the service request and provide the feedback after the service delivery.

As illustrated in FIG. 6, a guest from the room 2 places the service request using the smart speaker. On receiving the service request, the service delivery engine 102 tracks the location of the staffs present at the hospitality unit. The service delivery engine 102 determines the location of the staffs using information from the devices carried by the staffs. For example, the devices carried by the staffs may support BLE and further the devices transmit the radio frequency. If any one of the receiving nodes receives the radio frequency transmitted by the at least one device carried by the at least one staff, the service delivery engine 102 determines the location of the at least one staff and assigns the suitable staff for the service delivery. As illustrated in FIG. 6, the service delivery engine 102 determines that the staff is nearer to the room 1 when the receiver node placed in the room 1 receives the radio frequency transmitted by the device carried by the staff. Thereafter, the service delivery engine 102 assigns the same staff to deliver the service to the guest staying in the room 2 as the location of the staff is nearer to the location of the guest who placed the service request. Thus, the services can be provided to the guest based on real-time requirements of the guests and location of the staffs.

In an embodiment, when the receiver node placed in the room 2 receives the radio frequency transmitted by the device carried by the staff, the service delivery engine 102 identifies the completion of the service delivery. Thus, the movement of the staffs can be tracked in real-time to measure the user experience.

FIG. 7 depicts an example scenario, wherein the blockchain based smart contract is initiated for fixing the faults determined in the functioning of appliances present in the user staying areas of the hospitality unit, according to embodiments as disclosed herein. Embodiments herein deploy sensors in the user staying areas of the hospitality unit. For example, a current sensor (sensor 1) may be connected to the AC and an environment sensor like a temperature sensor (sensor 2) may be placed in the room of the hotel as illustrated in FIG. 7. The monitoring engine 104 constantly collects the data from the current sensor and the temperature sensor. The monitoring engine 104 analyzes the data and detects fault in the functioning of the AC before receiving complaints from the guest. Based on the detected faults, the guest may be assisted to move to another room. Thus, improving the guest satisfaction during the guest's stay at the hotel.

Further, the monitoring engine 104 stores the data collected from the sensors in the storage unit 110. Further, the monitoring engine 104 sends the data collected from the sensors and information about the detected faults in the functioning of the AC to the server. The server further stores information about the detected faults in the blockchain based smart contract that can be further accessed by at least one of the administrator, the vendor, the guest and the external review sites. The smart contract raises an AC repair request to the vendor based on the detected faults. Once the fault in the functioning of the AC is fixed, the monitoring engine 104 may receive the acknowledgment message from the vendor. Based on the acknowledgement message, the monitoring engine 104 validates the functioning of the AC. Further, the monitoring engine 104 closes the smart contract and issues the payment to the vendor when the AC is functioning normally. Thus, any faults in the functioning of the appliances can be fixed before receiving complainants from the user.

Further, on receiving data from the temperature sensor, the monitoring engine 104 may detect that user required temperature is not maintained in the room. The monitoring engine 104 may set the temperature of the AC according to the user requirements.

The embodiments disclosed herein can be implemented through at least one software program running on at least one hardware device and performing network management functions to control the network elements. The network elements shown in FIG. 1 and FIG. 2 include blocks, which can be at least one of a hardware device, or a combination of hardware device and software module.

The embodiments disclosed herein describe methods and systems for measuring and improving user satisfaction during a stay of a user at a hospitality unit. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments herein can be practiced with modification within the spirit and scope of the claims as described herein.

What is claimed is:

1. A method for measuring real-time user satisfaction score in hospitality industry, the method comprising:
delivering, by a service delivery engine, at least one service to at least one user staying at a hospitality unit in response to receiving information about at least one requirement of the at least one user;
calculating, by the service delivery engine, a staff availability score based on delivery of the at least one service to the at least one user;
monitoring, by a monitoring engine, functioning of at least one appliance present in at least one user staying area of the hospitality unit, wherein a blockchain based smart contract is initiated in response to detecting at least one fault in functioning of the at least one appliance;
calculating, by the monitoring engine, a digital comfort score based on the functioning of the at least one appliance present in the at least one user staying area of the hospitality unit;
receiving, by a feedback engine, at least one feedback from the at least one user for at least one of the delivery of the at least one service, the functioning of the at least one appliance and at least one front-desk service, wherein the at least one feedback includes at least one of at least one service feedback and at least one front-desk feedback;
calculating, by the feedback engine, a feedback score for the at least one user based on the at least one feedback received from the at least one user; and
predicting, by a score prediction engine, at least one user satisfaction score for the at least one user during a stay of the at least one user at the hospitality unit, wherein the at least one user satisfaction score is predicted based on at least one of the staff availability score, the digital comfort score and the feedback score.

2. The method of claim 1, wherein delivering the at least one service to the at least one user includes
tracking location of at least one staff in response to receiving at least one service request from the at least one user, wherein the location of the at least one staff is tracked using at least one device carried by the at least one staff and the at least one device supports at least one of Beacon, iBeacon and Bluetooth Low Energy (BLE); and
assigning a staff from the at least one staff for delivering the at least one service to the at least one user based on the tracked location of the at least one staff.

3. The method of claim 2, further comprising tracking, by the service delivery engine, completion of delivery of the at least one service by scanning a unique identifier (ID) of the at least one device carried by the at least one staff.

4. The method of claim 1, wherein the staff availability score is calculated using time series data related to at least one of movement of the at least one staff while delivering the at least one service, time taken to deliver the service and at least one user input received from the at least one user for the at least one staff after delivering the at least one service.

5. The method of claim 1, wherein monitoring the functioning at least one appliance present in the at least one user staying area includes
collecting data from at least one sensor connected to the at least one appliance;
detecting at least one fault in functioning of the at least one appliance based on the data collected from the at least one sensor, wherein the at least one fault is detected using at least one of a supervised machine learning model and an unsupervised machine learning model; and
initiating the blockchain based smart contract for fixing the at least one fault detected in the functioning of the at least one appliance.

6. The method of claim 5, wherein initiating the blockchain based smart contract for fixing the at least one fault includes
configuring the blockchain based smart contract with at least one pre-defined term of contract;
sending at least one repair request to at least one vendor for fixing the at least one fault based on the at least one pre-defined term of contract;
checking the functioning of the at least one appliance in response to receiving an acknowledgment message from the at least one vendor after fixing the at least one fault;
closing the smart contract in response to determining the functioning of the at least one appliance is normal; and
issuing payment to the at least one vendor based on the at least one pre-defined term of contract for fixing the at least one fault detected in the functioning of the at least one appliance.

7. The method of claim 6, wherein the at least one pre-defined term of contract includes at least one of pricing information, closure time to fix the at least one fault, severity associated with the at least one fault and applicable penalty charges for taking extra time to fix the at least one fault.

8. The method of claim 1, wherein the digital comfort score is calculated using at least one of the data collected from the at least one sensor connected to the at least one appliance and the determined at least one fault.

9. The method of claim 1, wherein calculating the feedback score for the at least one user includes
calculating a service feedback score for the at least one user based on the delivery of the at least one service to the at least one user;
calculating a front-desk feedback score for the at least one user based on the at least one front-desk service; and
calculating the feedback score based on at least one of the service feedback score and the front-desk feedback score.

10. The method of claim 9, wherein calculating the service feedback score includes
receiving the at least one service feedback from the at least one user after the delivery of the at least one service to the at least one user;
detecting at least one emotion associated with the at least one service feedback received from the at least one user; and
calculating the service feedback score based on the detected at least one emotion.

11. The method of claim 9, wherein calculating the front-desk feedback score includes
detecting at least one facial emotion of the at least one user for the at least one front-desk service, wherein the at least one facial emotion is detected using real-time video analytics;
receiving the at least one front-desk feedback from the at least one user for the at least one front-desk service; and
calculating the front-desk feedback score based on the at least one of the at least one facial emotion of the at least one user and the received at least one front-desk feedback.

12. The method of claim 1, further comprising:
monitoring, by the feedback engine, behavior of the at least one staff while handling the at least one front-desk service, wherein the behavior of the at least one staff is monitored using real-time video analytics; and
calculating, by the feedback engine, a performance score for the at least one staff based on the behavior of the staff while handling the at least one front-desk service.

13. The method of claim 1, wherein the at least one user satisfaction score is stored in the blockchain.

14. The method of claim 1, further comprising:
sending, by the score prediction engine, at least one review closure request to the at least one user to validate the at least one user satisfaction score, wherein the at least one review closure request includes the at least one user satisfaction score;
receiving, by the score prediction engine, at least one closure review response from the at least one user for the at least one review closure request, wherein the at least one closure review response includes at least one of approval of the at least one user satisfaction score and rejection of the at least one user satisfaction score and the at least one closure review response is stored in the blockchain; and
awarding, by the score prediction engine, at least one royalty point to the at least one user depending on time taken to receive the at least one closure review response from the at least one user.

15. The method of claim 1, further comprising:
receiving, by the feedback engine, at least one external review score from the at least one external review site, wherein the at least one external review score is provided by the at least one user for the hospitality unit in the at least one external review site;
comparing, by the score prediction engine, the at least one external review score with the at least one user satisfaction score; and
awarding, by the score prediction engine, at least one higher royalty point to at least one of the at least one vendor, the at least one staff and the at least one user in response to determining the at least one external review score is higher than the at least one user satisfaction score.

16. A hospitality system for measuring real-time user satisfaction score in hospitality industry, the system comprises:
a service delivery engine configured to:
deliver at least one service to at least one user staying at a hospitality unit in response to receiving information about at least one requirement of the at least one user;
calculate a staff availability score based on delivery of the at least one service to the at least one user;
a monitoring engine configured to:
monitor functioning of at least one appliance present in at least one user staying area of the hospitality unit, wherein a blockchain based smart contract is initiated in response to detecting at least one fault in functioning of the at least one appliance;
calculate a digital comfort score based on the functioning of the at least one appliance present in the at least one user staying area of the hospitality unit;
a feedback engine configured to:
receive at least one feedback from the at least one user for at least one of the delivery of the at least one service, the functioning of the at least one appliance and at least one front-desk service, wherein the at least one feedback includes at least one of at least one service feedback and at least one front-desk feedback;
calculate a feedback score for the at least one user based on the at least one feedback received from the at least one user; and
a score prediction engine configured to:
predict at least one user satisfaction score for the at least one user during a stay of the at least one user at the hospitality unit, wherein the at least one user satisfaction score is predicted based on at least one of the staff availability score, the digital comfort score and the feedback score.

17. The hospitality system of claim 16, wherein the service delivery engine is further configured to:
track location of at least one staff in response to receiving at least one service request from the at least one user, wherein the location of the at least one staff is tracked using at least one device carried by the at least one staff and the at least one device supports at least one of Beacon, iBeacon and Bluetooth Low Energy (BLE); and
assign a staff from the at least one staff for delivering the at least one service to the at least one user based on the tracked location of the at least one staff.

18. The hospitality system of claim 17, wherein the service delivery engine is further configured to track completion of delivery of the at least one service by scanning a unique identifier (ID) of the at least one device carried by the at least one staff.

19. The hospitality system of claim 16, wherein the staff availability score is calculated using time series data related to at least one of movement of the at least one staff while delivering the at least one service, time taken to deliver the service and at least one user input received from the at least one user for the at least one staff after delivering the at least one service.

20. The hospitality system of claim 16, wherein the monitoring engine is further configured to:
collect data from at least one sensor connected to the at least one appliance;
detect at least one fault in functioning of the at least one appliance based on the data collected from the at least one sensor, wherein the at least one fault is detected using at least one of a supervised machine learning model and an unsupervised machine learning model; and
initiate the blockchain based smart contract for fixing the at least one fault detected in the functioning of the at least one appliance.

21. The hospitality system of claim 20, wherein the monitoring engine is further configured to:
configure the blockchain smart contract with at least one pre-defined term of contract;
send at least one repair request to at least one vendor for fixing the at least one fault based on the at least one pre-defined term of contract;
check the functioning of the at least one appliance in response to receiving an acknowledgment message from the at least one vendor after fixing the at least one fault;
close the smart contract in response to determining the functioning of the at least one appliance is normal; and
issue payment to the at least one vendor based on the at least one pre-defined term of contract for fixing the at least one fault detected in the functioning of the at least one appliance.

22. The hospitality system of claim 21, wherein the at least one pre-defined term of contract includes at least one of pricing information, closure time to fix the at least one fault, severity associated with the at least one fault and applicable penalty charges for taking extra time to fix the at least one fault.

23. The hospitality system of claim 16, wherein the digital comfort score is calculated using at least one of the data collected from the at least one sensor connected to the at least one appliance and the determined at least one fault.

24. The hospitality system of claim 16, wherein the feedback engine is further configured to:
calculate a service feedback score for the at least one user based on the delivery of the at least one service to the at least one user;
calculate a front-desk feedback score for the at least one user based on the at least one front-desk service; and
calculate the feedback score based on at least one of the service feedback score and the front-desk feedback score.

25. The hospitality system of claim 24, wherein the feedback engine is further configured to:
receive the at least one service feedback from the at least one user after the delivery of the at least one service to the at least one user;
detect at least one emotion associated with the at least one service feedback received from the at least one user; and
calculate the service feedback score based on the detected at least one emotion.

26. The hospitality system of claim 24, wherein the feedback engine is further configured to:
detect at least one facial emotion of the at least one user for the at least one front-desk service, wherein the at least one facial emotion is detected using real-time video analytics;
receive the at least one front-desk feedback from the at least one user for the at least one front-desk service; and
calculate the front-desk feedback score based on the at least one of the at least one facial emotion of the at least one user and the received at least one front-desk feedback.

27. The hospitality system of claim 16, wherein the feedback engine is further configured to:
monitor behavior of the at least one staff while handling the at least one front-desk service, wherein the behavior of the at least one staff is monitored using real-time video analytics; and
calculate a performance score for the at least one staff based on the behavior of the staff while handling the at least one front-desk service.

28. The hospitality system of claim 16, wherein the at least one user satisfaction score is stored in the blockchain.

29. The hospitality system of claim 16, wherein the score prediction engine is further configured to:
send at least one review closure request to the at least one user to validate the at least one user satisfaction score, wherein the at least one review closure request includes the at least one user satisfaction score;
receive at least one closure review response from the at least one user for the at least one review closure request, wherein the at least one closure review response includes at least one of approval of the at least one user satisfaction score and rejection of the at least one user satisfaction score and the at least one closure review response is stored in the blockchain; and
award at least one royalty point to the at least one user depending on time taken to receive the at least one closure review response from the at least one user.

30. The hospitality system of claim 16, wherein the hospitality system is further configured to:
receive at least one external review score from the at least one external review site, wherein the at least one external review score is provided by the at least one user for the hospitality unit in the at least one external review site;
compare the at least one external review score with the at least one user satisfaction score; and
award at least one higher royalty point to at least one of the at least one vendor, the at least one staff and the at least one user in response to determining the at least one external review score is higher than the at least one user satisfaction score.
